(19) United States
(12) Patent Application Publication
(10) Pub. No.: US 2020/0056654 A1
(43) Pub. Date: Feb. 20, 2020

(54) METHOD AND APPARATUS FOR REPLACING A ROLLER ON A DEFECTIVE SHAFT

(71) Applicant: Richard C. Brown, Casco, MI (US)

(72) Inventor: Richard C. Brown, Casco, MI (US)

(21) Appl. No.: 15/885,394

(22) Filed: Jan. 31, 2018

Related U.S. Application Data
(60) Provisional application No. 62/454,285, filed on Feb. 3, 2017.
(60) Provisional application No. 62/586,424, filed on Nov. 15, 2017.

(51) Int. Cl. F16C 19/22; F16C 33/46

(52) U.S. Cl. CPC F16C 19/22; B60P 1/6418; F16C 33/4605

(57) ABSTRACT

A kit of replacement parts and a method are used to replace a roller on a defective pin including a washer and a retaining pin. The invention is particularly useful in conjunction with roll-off trucks and trailers. The method includes the steps of removing the retaining pin, washer and roller from the defective pin, placing a new sleeve over the defective pin, placing a new roller over the new sleeve, placing a new washer over the sleeve, and installing a new retaining component to maintain the position of the new sleeve, roller and washer. In accordance with one embodiment, the new retaining component is a retailing pin used to replace an old retaining pin. According to an alternative embodiment, the new retaining component is a snap retaining ring. The sleeve is preferably hardened, and the defective pin may have a nominal O.D. of 2 inches.

### REFERENCE TO RELATED APPLICATIONS

This application claims priority to U.S. Provisional Patent Application Ser. No. 62/454,285, filed Feb. 3, 2017, and U.S. Provisional Patent Application Ser. No. 62/586,424, filed Nov. 15, 2017, the entire content of both applications being incorporated herein by reference.

### FIELD OF THE INVENTION

This invention relates generally to roll-off trailers and, in particular, to methods and apparatus for replacing a roller on a defective shaft.

### BACKGROUND OF THE INVENTION

Roll-off trailers are used to drop off and pick up heavy metal containers used for various jobs that need considerable waste material to be hauled away. Examples include construction debris generated at building sites where something is being built, renovated, or demolished. The material in the roll-off may be taken to a landfill, recycled or otherwise disposed of.

The roll-off container itself is a usually open-top rectangular metal dumpster with wheels to facilitate rolling the dumpster in place. The containers are designed to be transported by special roll-off trucks or trailers. Such vehicles typically include a pivoting frame with rails and wheels that the container moves across while being loaded and unloaded.

Roll-off containers can be filled with materials that are extremely heavy, such as brick, concrete and metal components. As such the containers, when filled, can weight thousands of pounds, and the rollers on the trailer can experience considerable abuse. More particularly, the rollers are journaled onto metal shafts or “pins” which can become eroded or deformed due to uneven wear, requiring maintenance.

The rollers on roll-off trailers are currently very difficult to maintain and repair. When sufficiently compromised, the pins that receive the rollers need to be removed and replaced, which generally involves cutting out the damaged pin(s) from the truck frame and welding new ones in place. Unfortunately, due to the way in which the trailers are constructed, access to the pins can be limited, causing the replacement process to be tedious and time-consuming.

### BRIEF DESCRIPTION OF THE DRAWINGS

FIG. 1 shows a typical roller configuration on a roll-off trailer;

FIG. 2 illustrates a repair according to the invention;

FIG. 3A is a side view of a replacement, hardened steel sleeve with preferred dimensions;

FIG. 3B is an end-on view of the sleeve of FIG. 3A;

FIG. 4A is a side view of a replacement roller for use with the sleeve of FIGS. 3A, B;

FIG. 4B is an end-on view of the replacement roller of FIG. 4A; and

FIG. 5 illustrates an alternative embodiment of the invention that uses a retaining ring as opposed to a roll pin.

### SUMMARY OF THE INVENTION

This invention is directed to a kit of replacement parts and a method of replacing a roller on a defective pin including a washer and a retaining pin. The invention is particularly useful in conjunction with roll-off trucks and trailers.

The method includes the steps of removing the retaining pin, washer and roller from the defective pin, placing a new sleeve over the defective pin, placing a new roller over the new sleeve, placing a new washer over the sleeve, and installing a new retaining component to maintain the position of the new sleeve, roller and washer.

In accordance with one embodiment, the new retaining component is a retailing pin used to replace the old retaining pin, with the method further including the steps of:
removing the old retaining pin along with the washer and roller from the defective pin;
providing a sleeve with transverse holes to receive a new retaining pin; and
installing the new retaining pin through the sleeve and defective pin in the position previously occupied by the old retaining pin to hold the sleeve, roller and washer in position.

According to an alternative embodiment, the new retaining component is a snap retaining ring, and the method includes the steps of:
providing a new sleeve with a circumferential groove to receive the snap retaining ring; and
installing a snap retaining ring onto the groove to hold the sleeve, roller and washer in position.

In the preferred embodiment, wherein the pin forms part of a roll-off truck or trailer, the sleeve is hardened, and the defective pin has a nominal O.D. of 2 inches. The sleeve may have a rear collar, and the sleeve has grease-receiving recess.

### DETAILED DESCRIPTION OF THE INVENTION

In broad and general terms, this invention allows rollers to be replaced on defective pins in roll-off trailers (and other applications) without removing or replacing the pin itself.

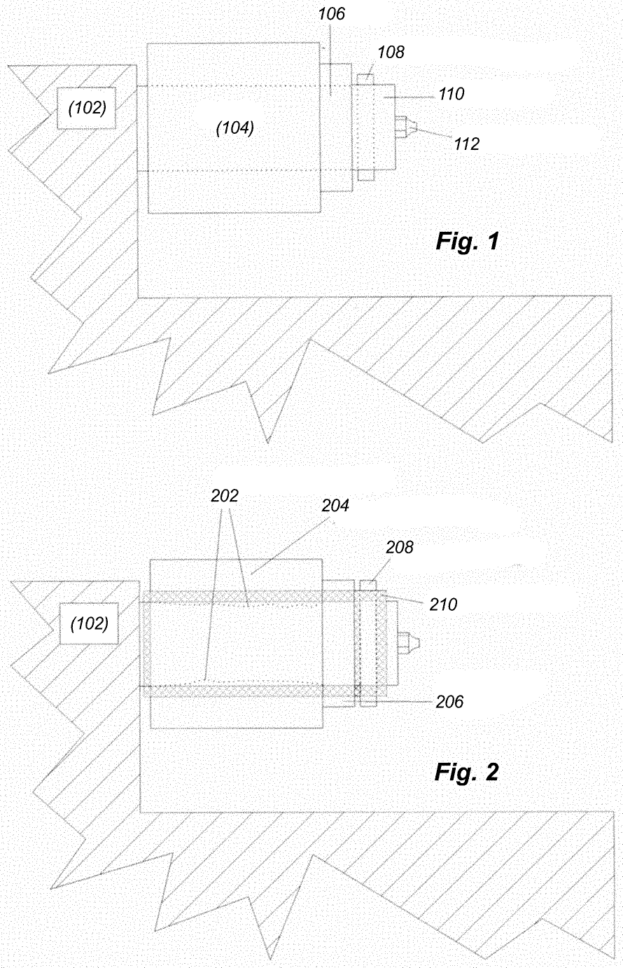

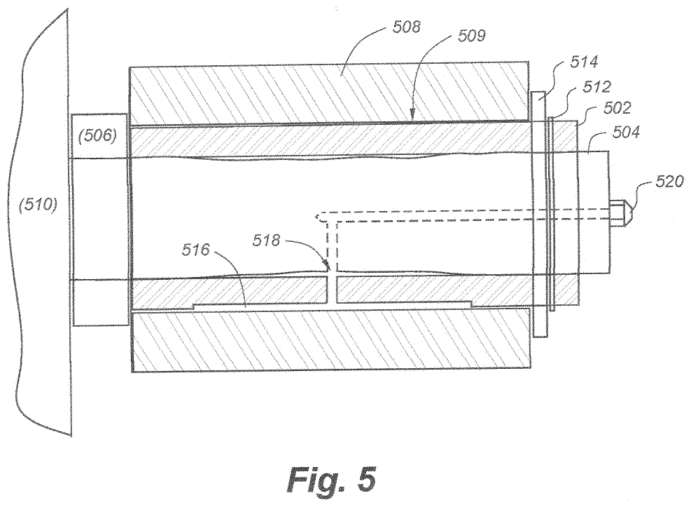

FIG. 1 shows a typical roller configuration on a roll-off trailer. The roller is journaled over a “pin,” typically a 2-inch diameter steel post or shaft 110 that is welded to the truck frame 102. A washer 106 is installed on the pin 110 next to the roller 104, and the roller and washer are secured with a retainer roll pin 108 that extends through the pin 110. A grease fitting 112 delivers grease to the assembly as shown in FIG. 5.

FIG. 2 shows a repair according to the invention. The components are depicted in partial cross section. Note that the pin itself has experienced uneven wear resulting in an irregular surface 202. In many situations, while the roller and washer are readily accessible through removal of the retaining pin, removal and replacement of the pin itself can be problematic. This invention addresses this problem.

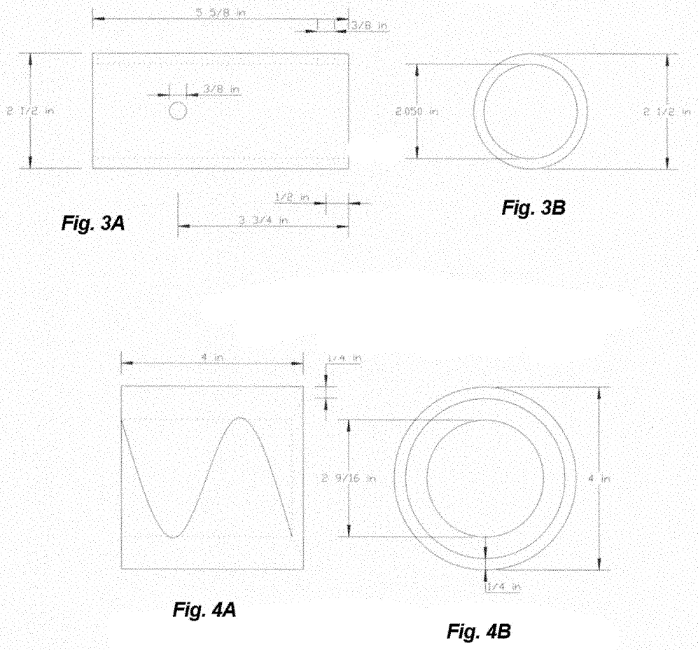

In accordance with this invention, the retaining pin 108 is removed and the existing roller 104 and washer 106 are taken off of the pin. A hardened steel sleeve 210, shown in FIGS. 3A, B is placed right over the defective pin, and a new washer with a larger inner diameter is placed over the new, hardened sleeve. The new sleeve has a transverse holes to receive a new retaining roll pin 208 that extends through the hardened sleeve and the defective pin. The new retaining pin 208 is preferably longer than the removed pin to ensure that the new washer and roller are properly retained. It is recommended that the end of the sleeve facing the truck frame be at least tack-welded to the frame to prevent rotation thereof.

FIGS. 3A, B show a replacement, hardened steel sleeve, while FIGS. 4A, B shows the replacement roller. The replacement washer has the same width and O.D. as the removed washer, but has an I.D. such as 2 9/16 enabling it to freely rotate around the 2.5″ O.D. of the replacement sleeve.

The wavy line in FIG. 4A represents a grease-distribution groove on the inner surface of the roller. Note that while the dimensions provided in FIGS. 3, 4 are exemplary for a typical roll-off trailer, the invention is not limited to these or any other precise dimensions so long as the goal of sleeving a defective pin, shaft or spindle is met as disclosed herein.

FIG. 5 illustrates an alternative embodiment of the invention. Again, a hardened sleeve 502 is journaled over steel pin 504. Sleeve 502 may have a collar 506 positioned against truck frame 510. A replacement roller 508 is placed over sleeve 502, but held in position with a snap ring 512 as opposed to a new roll pin.

Roller 508 may have an O.D. of 4 inches and an I.D. of 2¾ inches, and may include a bushing 509 made of aluminum, bronze or other material to avoid steel-steel contact. A washer 514 is preferably disposed between the snap ring 512 and outer edge of the roller 508. Also, a bottom relief 516 may be provided on sleeve 502 enabling grease from fitting 520 to collect through grease port 518. The use of a sleeve with a collar, roller with a bushing, snap ring and/or bottom relief may also be used with any of the other embodiments described herein.

1. A method of replacing a roller on a defective pin including a washer and a retaining pin, comprising the steps of:
removing the retaining pin, washer and roller from the defective pin;
placing a new sleeve over the defective pin;
placing a new roller over the new sleeve;
placing a new washer over the sleeve; and
installing a new retaining component to maintain the position of the new sleeve, roller and washer.

2. The method of claim 1, wherein the new retaining component is a retailing pin used to replace an old retaining pin, and the method includes the steps of:
removing the old retaining pin along with the washer and roller from the defective pin;
providing a sleeve with transverse holes to receive a new retaining pin; and
installing the new retaining pin through the sleeve and defective pin in the position previously occupied by the old retaining pin to hold the sleeve, roller and washer in position.

3. The method of claim 2, wherein the new retaining pin is longer than the old retaining pin.

4. The method of claim 1, wherein the new retaining component is a snap retaining ring, and the method includes the steps of:
providing a new sleeve with a circumferential groove to receive the snap retaining ring; and
installing a snap retaining ring onto the groove to hold the sleeve, roller and washer in position.

5. The method of claim 1, wherein the sleeve is hardened.

6. The method of claim 1, wherein the defective pin has a nominal O.D. of 2 inches.

7. The method of claim 1, wherein the sleeve has a rear collar.

8. The method of claim 1, wherein the sleeve has grease-receiving recess.

9. The method of claim 1, wherein the defective pin forms part of a roll-off truck or trailer.
